(19) United States
(12) Patent Application Publication
(10) Pub. No.: US 2003/0055862 A1
(43) Pub. Date: Mar. 20, 2003

(54) Methods, systems, and articles of manufacture for managing systems using operation objects

(75) Inventor: Guruprasad Bhat, Nashua, NH (US)

Correspondence Address: Finnegan, Henderson, Farabow, Garrett & Dunner, L.L.P., 1300 I Street, N. W., Washington, DC, 20005-3315, US

(73) Assignee: Sun Microsystems, Inc.

(21) Appl. No.: 09/953,900

(22) Filed: Sep. 18, 2001

(51) Int. Cl. G06F 9/00

(52) U.S. Cl. 709/101; 709/203; 709/315

(57) ABSTRACT

A system and method for processing batch requests in a CIM system environment is disclosed. Methods, systems and articles of manufacture consistent with the present invention configure a client with a modified API that creates new CIMOperation objects for each operation included in a batch request. The CIMOperation objects are placed in a batch list of operations that are sent to a CIM object manager for processing. Furthermore, the modified client API returns an operation ID to the client for each operation included in the batch list. The CIM object manager, based on the type of protocol used by the client, processes each CIMOperation object included in the batch list to obtain a corresponding result. Each result is placed in a corresponding CIMOperation object included in the batch list received from the client. The batch list of CIMOperation objects embedded with the results is sent back to the client which may use the operation IDs to retrieve the result data located within each CIMOperation object.

### DESCRIPTION OF THE INVENTION

1. Field of the Invention

This invention relates to managing resources of a computer system, and more particularly, to methods, systems, and articles of manufacture for performing batch operations between a client and a server in a network configuration.

2. Background of the Invention

Computer systems have become increasingly more complex. With a variety of peripheral devices and software applications available for use, it has become more complicated for a user or system administrator to manage the resources of computer systems. Computer system resources such as attached devices, network connections, software application, etc., should all be managed to ensure proper and efficient operation of the system they are implemented within. In organizations that use a large number of computer systems remotely distributed, the task of managing the resources for each computer system can be overwhelming.

To address the needs of users and system administrators in charge of managing these distributed systems, some computer industry members have introduced the Web-Based Enterprises Management (WBEM) initiative. WBEM includes a standard for managing systems, networks, users and software applications through the use of Internet technology. Computer systems that operate management applications developed according to WBEM principles can share management data independently of vendor, protocol, operating system, and management standards.

One known standard for implementing WBEM is the Common Information Model (CIM). CIM is a common data model of a schema for describing the management of information in a network environment. It provides a common conceptual framework to classify and define parts of the network environment, and describe how they interact. The model is not bound to a particular implementation and enables distributed system management to take place between management systems and applications. The CIM enables applications to be built using management data from a plurality of management systems.

WBEM software includes tools and technology that software developers can use to create CIM-compliant applications that manage the environment of a computer system. Typically developers, located at a client, perform management tasks through a CIM configured manager process located at a remote server. The manager process may be responsible for handling all communications between a client and the server. Typically, the process may handle these communications using a repository, which is a memory that stores definitions of CIM classes and instances that may represent devices located at the server.

Generally, the client will manage the devices located at the server using the CIM objects defined in a repository. To manage these devices, a client may generate a request that requires the invocation of a CIM class method. Typically, such requests are processed by the client and servers one at a time. Thus, when multiple requests are created by the client, each request may require a remote call over the network, which may cause undesirable delays at the client.

To improve the efficiency of management operations performed by a CIM configured client, the Distributed Management Task Force (DMTF), which is a consortium of companies that have instituted the WBEM and CIM methodologies, has created a batch request capability for remote CIM operations. Although a batch request capability has been created by the consortium, there has yet to be an implementation of this capability within a CIM environment implemented based on an object oriented programming language such as the Java™ programming language. Furthermore, because a server may manage resources for a plurality of clients, each running on various platforms, portions of each client's application programming interfaces may have to be rewritten if modifications are made to the manager process operating at the server, as well as management applications executed by the client.

### SUMMARY OF THE INVENTION

It is therefore desirable to have a method and system that allows a server to manage batch requests from clients.

Methods, systems and articles of manufacture consistent with the present invention enable a client application to request a set of operations to be performed by a server. The client may create a batch request from the requested set of operations and return an identifier associated with each operation in the set to the client application. The client may then send the batch request to an object manager operating at the server.

Additionally, methods, systems and articles of manufacture consistent with the present invention enable the object manager to direct each operation included in the batch request to a component of the server that is capable of handling the requested operation. The component may return a result that corresponds to the requested operation to the object manager. Each result may be placed in a corresponding operation included in the batch request received from the client. Once each operation includes a result for each requested operation, the object manager may send the operations embedded with results back to the client. The client may then create a batch result object from the received operations and forward it to the client application to retrieve the results from the batch result object for processing.

Additional aspects of the invention will be set forth in part in the description which follows, and in part will be obvious from the description, or may be learned by practice of methods, systems, and articles of manufacture consistent with features of the present invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention. In the drawings,

FIG. 1 illustrates an exemplary CIM system environment in which methods, systems, and articles of manufacture, consistent with features and principles of the present invention may be implemented;

FIG. 2 illustrates a flowchart of an exemplary process performed by a client when handling a non-batch request, consistent with features and principles of the present invention;

FIG. 3 illustrates a flowchart of an exemplary process performed by a CIMOM when handling a non-batch request, consistent with features and principles of the present invention;

FIG. 4 illustrates a flowchart of the steps of an exemplary process performed by a client handling a batch request, consistent with features and principles of the present invention;

FIG. 5 illustrates an exemplary block diagram of a CIMOperation class structure, consistent with features and principles of the present invention;

FIG. 6 illustrates another flowchart of the steps of an exemplary process performed by a client handling a batch request, consistent with features and principles of the present invention;

FIG. 7 illustrates a flowchart of the steps of an exemplary process performed by a CIMOM handling a batch request, consistent with features and principles of the present invention; and

FIG. 8 illustrates an exemplary block diagram of a CIMOM operation class structure associated, consistent with features and principles of the present invention.

### DETAILED DESCRIPTION

Methods, systems, and articles of manufacture consistent with features and principles of the present invention enable a client to manage resources located at a server by collecting a plurality of request operations into a single batch request and sending the request to the server for processing. Furthermore, methods, systems, and articles of manufacture consistent with features of the present invention enable the server to collect response data for each request operation and send the result data back to the client as a batch response message. The client may extract the response data from the server's collection for processing.

Methods, systems and articles of manufacture consistent with features of the present invention may perform the above functions by allowing the client to create an intermediary object of a batch class when the client needs to operate in a batch mode. The intermediary object may accept requests from a client application, and for each request, create a client side object and place it into a list. As the client side objects are created, an identifier associated with each client side object may be returned to the client application for retrieval purposes. The list of client side objects may then be sent to an object manager that may be operating at a server.

Additionally, methods, systems and articles of manufacture consistent with features of the present invention may configure the object manager to map each client side object in the list to a server side object. The object manager may use each server side object to retrieve a corresponding result from a component of the server. Each result may be embedded into a corresponding client side object. The list of client side objects, which include the results, may then be sent back to the client. The client may extract the results from each client side object in the list and place them into a batch result object. The batch result object may then be forwarded to the client application. The identifiers associated with each client side object may then be used by the client application to retrieve the results from the batch result object for processing.

In one configuration consistent with certain principles related to the present invention, the above operations may be performed by configuring a client to instantiate an object of a batch application programming interface (API), which may be an intermediary class of a WBEM API written in the Java programming language provided, and may be referred to as a Java WBEM API. The batch class may implement a batch interface that includes methods, which when invoked, creates a list of batch operations. The methods may also return operation identifiers (IDs) to the client application that may be used to retrieve results corresponding to the operations included in the batch list.

In another configuration consistent with certain principles related to the present invention, the batch API may be referenced to create an instance of an operation class for each method that is invoked in the batch interface. The newly created operation object is added to the list of batch operations. Once the list includes the set of operations the client application seeks to batch, a perform batch method defined under the operation class may be invoked. This invocation may return an instance of a batch result class that includes results corresponding to each operation object from an object manager operating within a server. The client application may use the batch result object to retrieve the results corresponding to each operation included in the batch request. In one configuration consistent with certain principles related to the present invention, the client application may use an operation ID that was assigned at the time each method was invoked on the batch class to retrieve a result.

In one configuration consistent with certain principles related to the present invention, the client may send a batch request using various remote procedure call protocols, such as Remote Method Invocation (RMI) compatible with the Java programming language and eXtensible Markup Language (XML) type requests transmitted over Hyper-Text Transfer Protocol (HTTP). For example, batch requests configured in XML/HTTP may be modified into a plurality of XML based “simplereq” operations each corresponding to a respective operation object and place them within a single XML based “multireq” operation.

In another configuration consistent with certain principles related to the present invention, the object manager may be configured to handle the batch request created by the API. The object manager may be configured to process batch requests received in various remote procedure call protocols. For example, the object manager may process XML/HTTP type requests by invoking each “simplereq” operation included within a “multireq” operation, retrieving result data from a component of the server, and configuring the result data as an XML based “simplersp” operation that is placed in an XML based “multirsp” operation for transmission back to the client. Alternatively, methods, systems, and articles of manufacture consistent with features and principles of the present invention may enable the object manager to process RMI batch requests by creating an object manager operation object for each operation object that is included in the batch list. Each object manager operation object may include a run method, which when invoked, enables the object manager to retrieve result data from either a repository or a provider that may be operating within the server. The result data for each object manager operation method that was invoked is placed in an array of objects, which in turn are placed in a server side batch result object that is sent back to the client for processing.

Reference will now be made in detail to the exemplary aspects of the invention, examples of which are illustrated in the accompanying drawings. Wherever possible, the same reference numbers will be used throughout the drawings to refer to the same or like parts.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

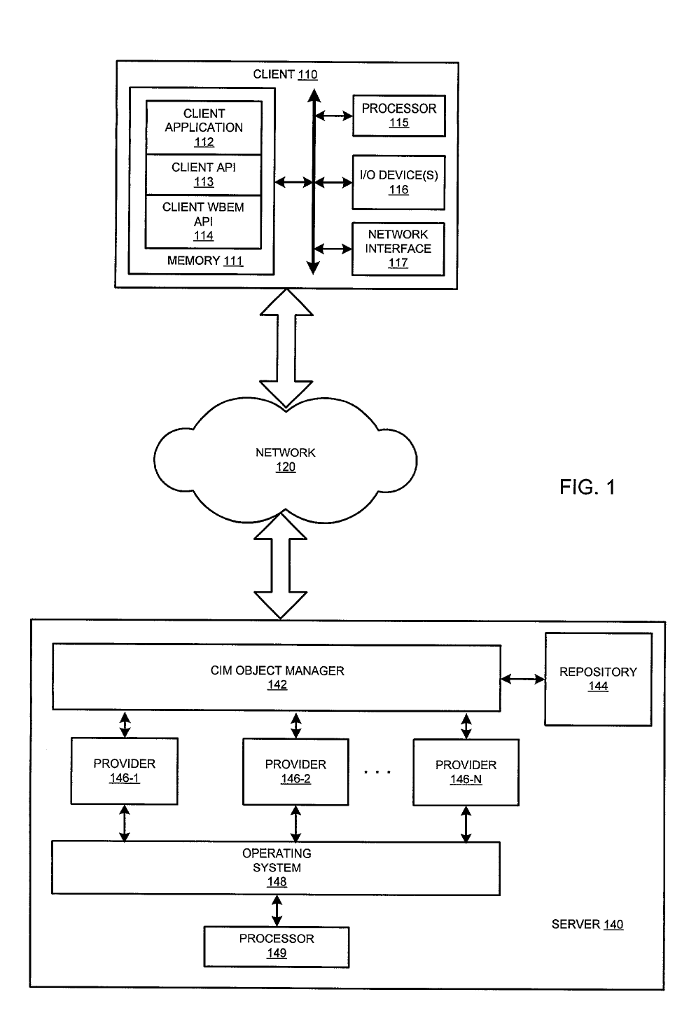

FIG. 1 illustrates an exemplary system environment in which features and principles consistent with the present invention may be implemented. As shown, the exemplary system environment may include a client 110, network 120 and a server 140. Client 110 may be a desktop computer, workstation, laptop, personal digital assistant or any other similar client side system known in the art. For example, client 110 may include a processor 115, associated memory 111, and numerous other elements and functionalities available in computer systems. These elements may include input/output devices 116 such as a keyboard, mouse and display, although these input means may take other forms. Also, included in client 110 may be a network interface 117 for communicating with network 120. In one configuration consistent with certain principles related to the present invention, client 110 may be a CIM configured client. A CIM configured client may be a client that implements CIM standards and techniques to manage resources located at a resource provider.

Memory 111 may include, among other software, client application 112, client API 113, and client WBEM API 114, consistent with features and principles of the present invention. Client application 112 may be a software application configured to analyze and manage resources located in server 140. Client application 112 may manage system aspects such as, for example, disk information (space availability, partitions, etc.), CPU load, event processing, date, time, ports, etc. Client application 112 may also manage specific devices of server 140, such as disks, tape drives, modems, remote I/O devices, and network interfaces. Furthermore, client application 112 may be configured to manage software applications running on server 140 by determining what applications are currently being executed by server 140, what applications are installed, the state of these applications, which applications can be terminated, and performing user and process management. A software developer operating client 110 may use any suitable software tool to develop a management application (client application 112) for managing resources provided by server 140.

Client API 113 may be an application programming interface used by client application 112 to communicate with Common Information Model Object Manager (CIMOM) 142 located in server 140. Client API 113 may use a variety of remote procedure call protocols, such as RMI and XML/HTTP, to communicate directly with CIMOM 142. Client API 113 may be used by client application 112 to transfer data to and from CIMOM 142 using a variety of classes, instances, and methods. Client API 113 may further be configured to process non-batch requests from client application 112 to CIMOM 142.

In one configuration related to certain principles related to the present invention, client API 113 may represent and manipulate objects of CIM classes that are implemented in the Java programming language. A CIM object may be a computer representation or model of a managed resource of server 140, such as a printer, disk drive, and CPU. A developer uses the CIM specification to describe managed objects and retrieve information about managed objects in server 140. Further information associated with the CIM specification may be found in the DMTF, Inc. Common Information Model (CIM) Specification, Version 2.2, Jun. 14, 1999, which is expressly incorporated by reference in its entirety.

Client WBEM API 114 may be an application programming interface that is configured to process batch requests, consistent with features and principles of the present invention. Client WBEM API 114 enables client 140 to batch multiple CIMClient API calls into a single remote call. Client WBEM API 114 may be configured within client API 113 or may be configured in another component of client 110.

Network 120 interconnects client 110 server 140. Network 120 may include one or more communication networks, including the Internet or any other similar network that supports Web-based processing.

Server 140 may be a computer system having resources capable of being managed, such as CPU load, disk space installed applications, etc. Server 140 may include a desktop computer, workstation, or any other similar server side system known in the art. Furthermore, server 140 may include, among other things a CPU, associated memory, and numerous other elements and functionalities available in computer systems (all not shown). Additionally, server 140 includes CIMOM 142, repository 144, providers 146-1 to 146-N, operating system 148, and processor 149.

CIMOM 142 may be a WBEM compliant manager that manages CIM objects that may be represented as classes written in the Java programming language. Client 110 running client application 112 may request a communication with CIMOM 142 through client API 113, and possibly client WBEM API 114, and network 120 to obtain resource information about server 140. Once communication is established, client 110 may receive a reference to CIMOM 142, which client 110 may use to perform WBEM operations with CIMOM 142 over network 120.

CIMOM 142 communicates with either repository 144 or an appropriate provider 146-1 to 146-N, to obtain information about an object requested by client 140. When an operation is requested by client 110, CIMOM 142 may direct the operation to repository 144 to determine whether it can process the operation. If not, CIMOM 142 may direct the requested operation to providers 146-1 to 146-N to determine whether they may handle the operation. CIMOM 142 may also perform other functions such as setting up communication paths with repository 144 and providers 146-1 to 146-N to route requests thereto, performing security checks, and delivering data from providers 146-1 to 146-N and repository 144 to client 110. In one configuration consistent with certain principles related to the present invention, CIMOM 142 may be modified to understand and process batch requests from client 110 in various protocols, including RMI and XML/HTTP.

Repository 144 may be a central storage area for CIM classes and instance definitions. One system consistent with certain principles related to the present invention may store WBEM classes in repository 144 as specialized objects written in an object oriented programming language, such as the Java programming language.

Providers 146-1 to 146-N may perform various functions in response to a request from CIMOM 142 and act as intermediaries between CIMOM 142 and one or more managed devices. For instance, providers 146-1 to 146-N may map information from a managed device to a CIM class written in an object oriented programming language, such as the Java programming language. For exemplary purposes, the CIM class may be referred to as a CIM Java class. Furthermore, providers 146-1 to 146-N may also map information from the CIM Java class to a managed device format. Providers 146-1 to 146-N may supply instances of a given class and support the retrieval, enumeration, modification, and deletion operations associated with managed objects. Furthermore, providers 146-1 to 146-N may supply property values associated LAW OFFICES with managed objects, such as disk space. Each provider 146-1 to 146-N may be dedicated to a particular type of operations, such as supplying dynamic property values associated with managed objects. Alternatively, providers 146-1 to 146-N may act collectively to process a request received from CIMOM 142. Server 140 may also be configured with only a single provider that handles all communications between CIMOM 142 and operating system 148.

Operating system 148 may be any suitable operating system such as the Solaris® operating system from Sun Microsystems, Inc. Processor 149 may be a workstation or CPU that communicates with operating system 148 to process information associated with providers 146-1 to 146-N and resources provided by server 140.

Although FIG. 1 shows a single client 110, it should be noted that more than one client 110 may be in communication with server 140. Furthermore, a plurality of servers 140 may also be used with one or more clients 110 to perform functions consistent with features and principles of the present invention. Furthermore, client 110 and server 140 may be located in the same computer system, with communications between the two facilitated by a communication bus or link.

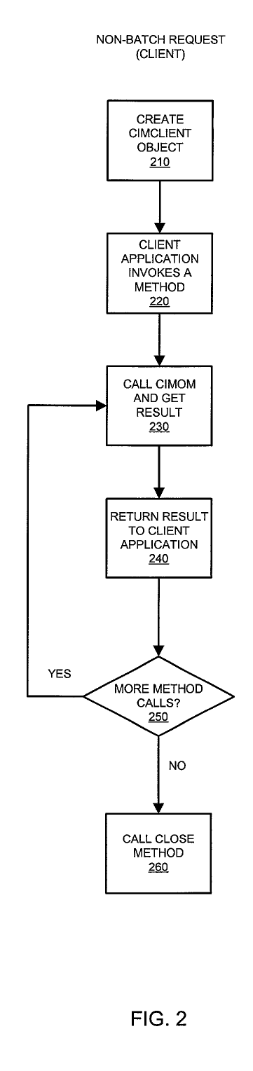

A request from client 110 may involve the invocation of a method associated with a CIM class defined by CIMOM 142. CIM classes may be have been previously defined by CIMOM 142 and placed in either repository 144 and/or other components in server 140 that may be accessed by operating system 148. Requests that may require the invocation of a single method are known as simple operations, or non-batch operations, while requests that require the invocation of more than one method are known as multiple operations, or batch operations. FIG. 2 illustrates a flowchart of a process performed at by client 110 associated with a non-batch request. When client application 112 initiates a request, the client API 113 first creates an object, which may be an instance of a CIMClient class (Step 210). The CIMClient class includes a finite number of methods that correspond to various tasks that may be performed by CIMOM 142 to fulfill a request created by client application 112. Once an instance of CIMClient class is created by client application 112, a particular method is invoked associated with the type of request (Step 220). This invocation results in a call to CIMOM 142 through client API 113. CIMOM 142 processes the request and returns a result to client API 113 (Step 230). Client API 113 then passes the result to client application 112 for processing (Step 240). Once the result is received by client application 112, client API 113 may check to determine whether client application 112 has any more requests that require method calls (Step 250). If not (Step 250; NO), a close method is called, and the non-batch request process ends (Step 260). On the other hand, if client application 112 has another request, processing returns to Step 230 and the sequence repeats for the next request (Steps 230-250).

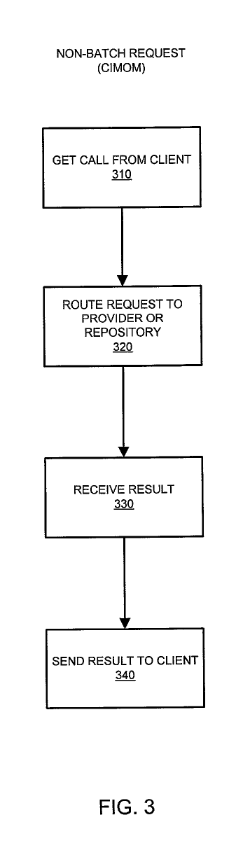

FIG. 3 illustrates an exemplary process performed by CIMOM 142 when processing a non-batch request. When CIMOM 142 receives a call from client API 113 (Step 310), it routes the request to either a provider 146-1 to 146-N or repository 144 (Step 320). The request is routed based on the type of request provided by client API 113, and whether the information may be obtained in repository 144 or not. In the event the information needed to process the request is not found in repository 144, CIMOM 142 may use provider 146-1 to 146-N to locate the system information 148 necessary to handle the request (if possible). Once the appropriate destination is located, CIMOM 142 eventually receives a result corresponding to the routed request (Step 330). The result is then sent back to client API 113 for processing by client application 112 (Step 340).

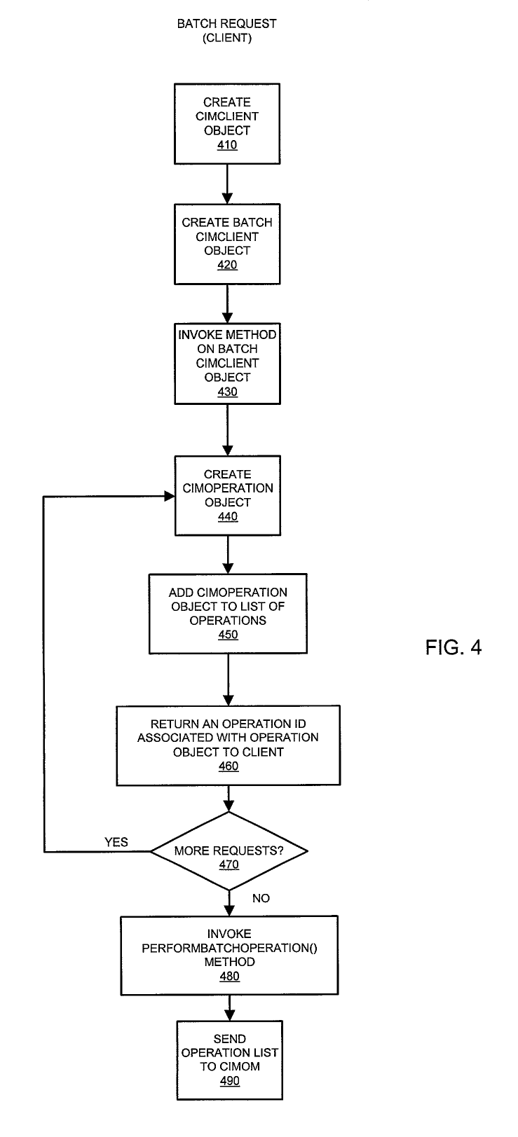

Methods, systems, and articles of manufacture consistent with features of the present invention allow client 110 to not only perform non-batch requests, as depicted in FIGS. 2 and 3, but also to perform batch requests. FIG. 4 illustrates a flowchart of an exemplary process performed by client 110 when a batch request is initiated.

When client application 112 wishes to perform a set of operations as a batch request, it first has to create an instance (object) of the CIMClient class, similar to that described in FIG. 2 (Step 410). Next, client application 112 creates an instance (object) of the BatchCIMClient class, which is a new class defined in client WBEM API 114 (Step 420). The BatchCIMClient class implements an interface named BatchHandle. The BatchHandle interface includes methods that may accomplish all the CIM operations that may be performed through the CIMClient class in non-batch mode. The BatchHandle methods are similar to the CIMClient methods in that they include the same or a similar set of parameters. There is one difference, however. The BatchCIMClient methods do not return the same types as their equivalent methods defined in the CIMClient class because the values are returned as a list after the batch operation is completed. Instead, the BatchHandle methods return an operation ID (OP ID) that may be used to retrieve the result of an operation at a later time.

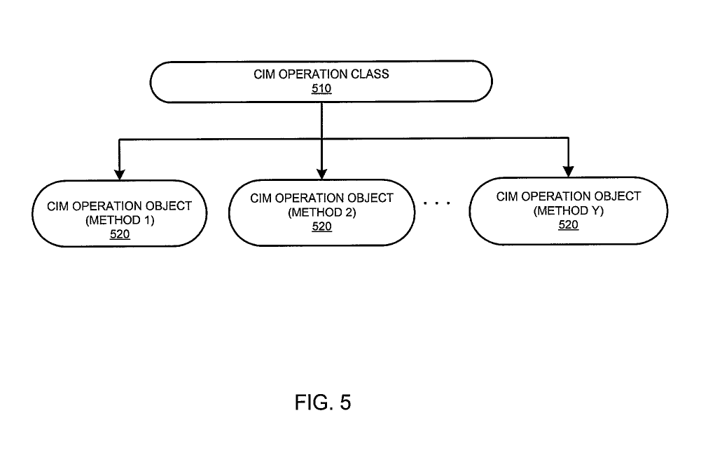

Each method in the BatchHandle interface includes a corresponding class which models the actual operation as an object. For instance, a getClass method includes a corresponding class called CIMGetClassOp. The corresponding classes are defined under a broad definition of CIMOperation classes. When client application 112 instantiates a BatchCIMClient object, a method associated with the type of request is invoked on the instantiated BatchCIMClient object (Step 430). The invocation of the BatchCIMClient method results in client WBEM API 114 creating a corresponding CIMOperation object. The newly created CIMOperation object encapsulates all of the information necessary to perform the operation associated with the request on server 140. FIG. 5 illustrates an exemplary class structure that shows subclasses of a CIMOperation class. As shown in FIG. 5, CIMOperation class 510 includes “Y” objects 520 that correspond to methods defined in the BatchCIMClient class. Thus, for each BatchCIMClient method that is invoked, a CIMOperation object 520 may be created.

After a CIMOperation object is created, client WBEM API 114 adds the object to a batch list of operations associated with the batch request (Step 450). In addition to adding the CIMOperation object to the batch list of operations, client WBEM API 114 also returns an operation ID (OP ID) to client application 112 associated with the CIMOperation object (Step 460). The OP ID allows client application 112 to locate a result received from CIMOM 142 at a later time (once a batch result is received). The OP ID may be stored in memory 111 or in a separate memory device (not shown) by client application 112 for subsequent use.

Next, client WBEM API 114 determines whether client application 112 has another request that requires an invocation of a BatchCIMClient method (Step 470). In the event there is another request (Step 470; YES), client WBEM API 114 invokes another method corresponding to the type of request, creates another corresponding CIMOperation object, adds the object to the batch list of operations, and returns an OP ID associated with the newly created CIMOperation object (Steps 430-460). On the other hand, if there are no more requests (Step 470; NO), client application 112 may execute the batch operation list. To do so, client application 112 uses a performBatchOperations method defined in the CIMClient class (Step 480). This method takes as its parameter an object that implements the BatchHandle interface. The previously created CIMClient object encodes the information included in the batch operation list on the chosen protocol for communicating with CIMOM 142 (RMI or XML/HTTP), and sends the information to CIMOM 142 using the chosen protocol (Step 490).

In one configuration consistent with certain principles related to the present invention, when the XML/HTTP protocol is used by client 110, the CIMOperation objects are converted to individual XML based “simplereq” calls and enclosed in an XML based “multireq” call before being sent to CIMOM 142. “Simplereq” and “multireq” calls are associated with <SIMPLEREQ> and <MULTIREQ> XML subelements, respectively, of <MESSAGE>, which in turn is an XML subelement of a root XML <CIM> element. The <CIM> element is defined under a CIM XML Document Type Descriptor (DTD). The <SIMPLEREQ> subelement is associated with a simple operation, which requires the invocation of a single method. A response to a simple operation request is represented by a subelement <SIMPLERSP>, defined within the <MESSAGE> subelement. The <MULTIREQ> subelement, on the other hand, is associated with a multiple operation request that requires the invocation of more than one method. A response to a multiple operation request is represented by a <MULTIRSP> subelement, also defined within the <MESSAGE> subelement. More information regarding CIM operations over the XML and HTTP protocols may be found in “Specification for CIM Operations over HTTP,” Version 1.0, DMTF, Inc., Aug. 11, 1999, which is hereby expressly incorporated by reference.

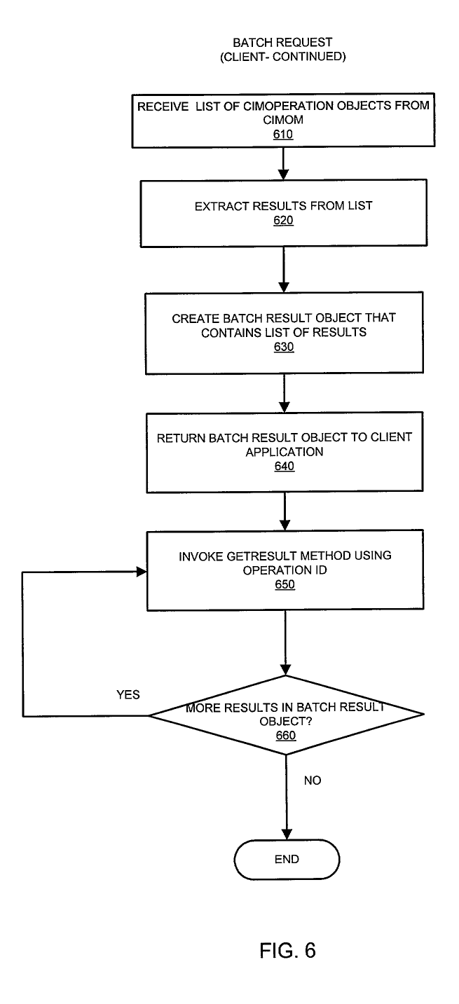

As described, client 110 performs various functions in preparing a batch request list of CIMOperation objects for processing by CIMOM 142. Once CIMOM 142 produces a result for each operation in the batch request, it embeds the result in a corresponding CIMOperation object included in the batch request list of CIMOperation objects received from client 110. and returns the list to client 110. FIG. 6 illustrates a flowchart of the exemplary processes performed by client 110 when the list of CIMOperation objects embedded with the results is received from CIMOM 142. As shown, client WBEM API 114 receives the list of modified CIMOperation objects associated with the batch request from CIMOM 142 (Step 610). The list may also be formed as a set or an array. In one configuration consistent with certain principles related to the invention, the list (set, or array) may be located within a BatchResult object received from CIMOM 142. In another configuration consistent with certain principles related to the present invention, the list is an array as defined by the Java programming language (i.e., a specialized type of class).

In one configuration consistent with certain principles related to the present invention, if the results received from CIMOM 142 were transferred using the XML/HTTP protocol, WBEM client API 114 may be configured to transform the results into a type of data that may be processed by client 110. That is, if the XML/HTTP protocol was used, the response may be received as an XML multiple response operation including a number of XML simple response operations. WBEM client API 114 may be configured to transform these XML operations into corresponding objects. For instance, in one configuration consistent with certain principles related to the present invention, the XML multiple operation may be transformed into a batch object including a set (list or array) of individual objects, which are transformed XML simple operations.

Returning to FIG. 6, once the result list is received, client WBEM API 114 may iterate over the list and pull out the results embedded within each CIMOperation object included in the list (Step 620). Once the results are extracted from the result list, client WBEM API 114 creates a client-side result object of a BatchResult class (Step 630). The BatchResult object contains the results of invoking the batch operation list by client application 112. Client WBEM API 114 then returns the BatchResult object to client application 112 (Step 640).

Client application 112 can now retrieve the results using a getResult method defined in the BatchResult class. The getResult method accepts an OP ID as an input parameter and returns a result object for a particular operation associated with the OP ID. Accordingly, client application 112 uses the OP IDs previously obtained from client WBEM API 114 when the batch operation list was created (FIG. 4; Step 460) as an input parameter for the getResult method (Step 650). The invocation of the getResult method using the OP ID results in the return of a result object to client application 112. The result object may be returned in a type corresponding to the respective method in the CIMClient class. That is, at this point, client application 112 receives a return value that is associated with the operation originally requested. The return value may also be the same data type as the requested operation's equivalent type defined in the CIMClient class (i.e., integer value, decimal value, string of characters, an individual character, etc.). Alternatively, if the operation included in the batch operation list resulted in a CIMException (i.e., CIMOM 142 could not process the operation), the exception is thrown from the getResult method and client application may provide a message indicating the exception. In one configuration consistent with certain principles related to the present invention, the exception message may be provided to a graphical user interface for review by a software developer or administrator located at client 110.

Returning to FIG. 6, once a result is retrieved for a particular operation, client application 112 may determine whether there are any more operations that need to be matched with corresponding results (Step 660). If so (Step 660; YES), client application 112 again uses an appropriate OP ID as an input parameter for the getResult method and retrieves the corresponding result from a newly generated result object (Step 650 and 660). Once all of the OP IDs are used by client application 112 to obtain all of the results for the batch request, the batch request process ends (Step 660; NO).

It should be noted that the manner by which client application 112 retrieves the result objects may be in the same order that the operations were placed in the batch operation list. Accordingly, the OP IDs may be sequentially numbered as integers. When client application 112 seeks to obtain the results for the operations included in the batch list, the OP IDs are presented in the same order as they were created. This way, tasks that are being performed by client application 112 that may be dependent upon each other will not receive results out of order, thus preventing the possibility of stale data being used by client 110.

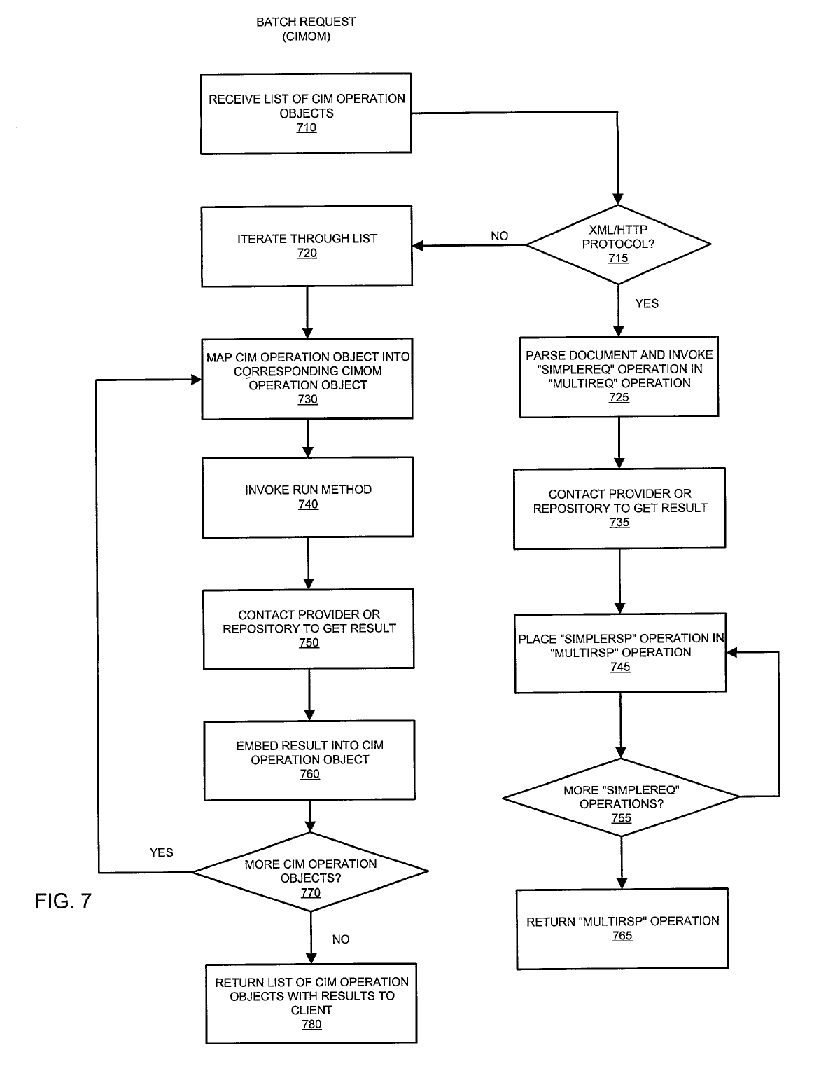

As described, methods, systems, and articles of manufacture, consistent with features and principles of the present invention enable a client to create a batch request using a modified client API and instances of the BatchCIMClient class, and the BatchHandle interface. In order to process the batch request, CIMOM 142 may be modified as well. FIG. 7 illustrates a flowchart of an exemplary batch request process performed by CIMOM 142. Initially, CIMOM 142 receives the batch list of CIMOperation objects created by client 110 (Step 710). Because CIMOM 142 may be configured to be protocol specific when processing batch requests, different functions may be performed to accept and deliver result objects to client 110.

Accordingly, the next step in the batch request process may be to determine whether a XML/HTTP protocol was used to send the batch list to CIMOM 142 (Step 715). If so (Step 715; YES), the “multireq” operation that may have been created by client 110 is parsed and each “simplereq” within the “multireq” operation is invoked in the order they were created. Thus, CIMOM 142 invokes the first “simplereq” operation in the parsed “multireq” operation (Step 725), and CIMOM 142 determines whether to contact the repository 144 or a provider 146-1 to 146-N to process the request (Step 735). In one configuration consistent with certain principles related to the present invention, CIMOM 142 determines whether the “simplereq” operation may be handled using the repository 144 first, and if not, an appropriate provider 146-1 to 146-N is accessed to handle the operation.

Once a response is obtained from either repository 144 or a provider 146-1 to 146-N, CIMOM 142 formats the response into a “simplersp” operation and places this operation within the “multirsp” operation for subsequent transmission to client 110 (Step 745). CIMOM 142 may then determine whether there any more “simplereq” operations in the “multireq” operation to process (Step 755), and if so, contacts the repository 144 or a provider 146-1 to 146-N to obtain result data (Step 735). On the other hand, if there are no more “simplereq” operations left to process, CIMOM 142 returns the “multirsp” operation back to client 110 using the same XML/HTTP protocol used by client 110 to deliver the “multireq” operation (Step 765).

Returning to Step 715, in the event client 110 used a protocol other than the XML/HTTP protocol (e.g., RMI protocol) to deliver the batch list of operations (Step 715; NO), CIMOM 142 may begin to iterate through the batch list to create server-side objects that correspond to the instances of the CIMOperation class created by client WBEM API 114 (Step 720). To do so, CIMOM 142 maps each CIMOperation object into a corresponding CIMOMOperation object, which are instances of a CIMOMOperation class. In one configuration consistent with certain principles related to the present invention, CIMOM 142 may use the reflection feature of the Java programming language to obtain information about the fields, methods, and constructors of the CIMOperation objects in the batch list of operations received form client 110. CIMOM 142 may use the reflection feature to ensure that the newly created CIMOMOperation objects have identical fields, methods, and constructors, as these objects' counterpart CIMOperation objects. For more information on the reflection feature of the Java programming language, see “Using Java Reflection,” Glen McCluskey, Java Developer Connection, Java.sun.com, January 1998, visited Jul. 12, 2001, which is hereby incorporated by reference.

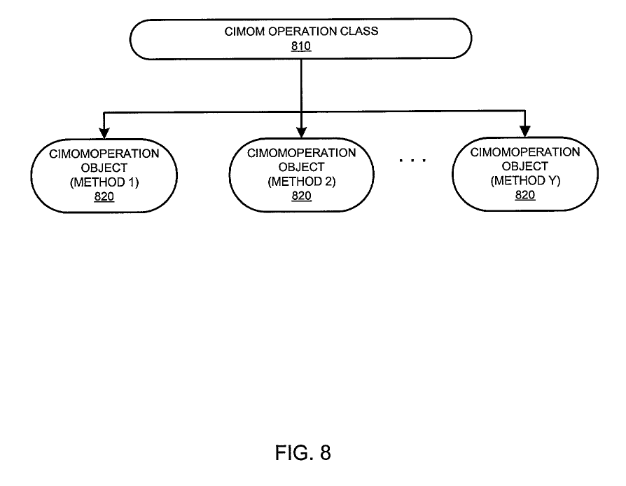

The CIMOMOperation class implements an interface called “Runnable” which contains a run method. Accordingly, each CIMOMOperation object that is created includes a run method. Each newly created CIMOMOperation object includes constructors that take in the same parameters as the CIMOperation objects created by WBEM client API 114, a handle to a CIMOMImpl object which implements the core CIMOM 142 functionalities, an instance of a ServerSecurity class, the corresponding CIMOperation object, and a version string. Therefore, each newly created CIMOMOperation object includes all of the information required to perform the operation stipulated in its corresponding CIMOperation object included in the batch list. For comparison purposes, FIG. 8 shows an exemplary block diagram of the CIMOperation class structure depicted in FIG. 5, along with a corresponding newly created CIMOMOperation class structure, consistent with features and principles of the present invention. As can be seen in FIG. 8, the newly created CIMOMOperation class 810 includes objects 820 that correspond to CIMOperation objects 510.

Returning to FIG. 7, Step 730, once a CIMOMOperation object is created, its run method is invoked by CIMOM 142, which in turn calls an appropriate method in the CIMOMInpl object (Step 740). This method enables CIMOM 142 to access either repository 144 or a provider 146-1 to 146-N to obtain result data associated with the request operation LAW OFFICES included in the batch list (Step 750). The CIMOMImpl method collects result data from repository 144 or providers 146-1 to 146-N and embeds the result data into the corresponding CIMOperation object included in the batch list received from client 110 (Step 760).

For example, a CIMOperation object may be associated with a request for an indication of remaining free disk space provided by server 140 and managed by client 110. A created CIMOMOperation object corresponding to this CIMOperation object may direct CIMOM 142 to access repository 144 to determine whether it may collect the appropriate information to handle this request. In the event repository 144 does not contain the CIM objects needed to process the disk space request, CIMOM 142 may then access an appropriate provider 146-1 to 146-N to obtain the proper result data for this exemplary request. The provider 146-1 to 146-N communicates with operating system 148, which in turn, accesses the appropriate resource (i.e., processor 149) to obtain information associated the remaining disk space managed by client 110. Subsequently, operating system 148 may return this information, if it is available, back to CIMOM 142 through the appropriate provider 146-1 to 146-N. CIMOM 142 may place the result data into the free disk space CIMOperation object.

Returning to FIG. 7, CIMOM 142 then determines whether there are any more CIMOperation objects to process (Step 770), and if so, maps the next CIMOperation object into a CIMOMOperation object (Step 730) and repeats Steps 740-760 for the newly created CIMOMOperation object. On the other hand, if there are no more CIMOperation objects in the batch list to process (Step 770; NO), CIMOM 142 may return the list of CIMOperation objects that are embedded with result data to client 110 (Step 780), where the batch request process shown in FIG. 6 may be performed.

As can be seen, methods, systems, and articles of manufacture consistent with features of the present invention allow a client to batch a set of operations for processing by a CIMOM operating at a server. The server is also configured to handle the batch set of operations and produce a batch result which is sent back to the client for processing.

Variations of the methods and systems consistent with features of the present invention previously described may be implemented without departing from the scope of the invention. For example, methods, systems, and articles of manufacture, consistent with features of the present invention may be implemented using various network models, and is not limited to a CIM environment. Furthermore, methods, systems, and articles of manufacture, consistent with features of the present invention are not limited to the implementation of systems and processes compliant with the Java programming language. Any number of programming languages may be utilized without departing from the scope of the present invention.

Additionally, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described aspects of the invention, but instead is defined by the appended claims in light of their full scope of equivalents.

What is claimed is:

1. A method for performing communications between a client and a server, the method performed by the client comprising:
creating an operation object reflecting an operation;
adding the operation object to a set of operation objects;
creating an operation identifier associated with the operation object;
sending the set of operation objects to the server;
receiving, from the server, the set of operation objects, wherein each operation object in the received set includes an associated result; and
using the operation identifier to retrieve a first result associated with the operation object from the received set of operation objects.

2. The method of claim 1, wherein receiving the set of operation objects from the server comprises:
creating a batch result object from the received set of operation objects; and
using the operation identifier to retrieve the first result from the batch result object.

3. The method of claim 2, wherein using the operation identifier comprises:
invoking a result method of a batch result class, wherein the operation identifier is used as an input parameter of the result method to retrieve the first result from the batch result object.

4. The method of claim 1, wherein the operation is a method associated with a Common Information Model (CIM) batch object of the batch result class and the operation object is created when the method is invoked.

5. The method of claim 1, wherein a Common Information Model (CIM) application programming interface (API) performs the steps of creating an operation object, adding, and creating an operation identifier.

6. The method of claim 1, wherein creating an operation identifier associated with the operation object comprises:
providing the operation identifier to a client application executing in the client.

7. The method of claim 6, wherein receiving the set of operation objects from the server comprises:
providing a batch result object associated with the received set of operation objects to the client application.

8. The method of claim 7, wherein the step of using the operation identifier is performed by the client application and further comprises:
using the operation identifier to retrieve the first result from the batch result object

9. The method of claim 1, wherein the client is a Common Information Model (CIM) configured client, and wherein the operation object is associated with a CIM class.

10. The method of claim 1, wherein sending the set of operation objects to the server comprises:
sending the set of operation objects to the server using one of RMI and XML/HTTP protocols.

11. A method for performing batch data transfers between a client and an object manager, comprising:
providing a set of request objects;
creating an identifier for each request object included in the set of request objects;
receiving a set of result objects, each result object in the set of result objects corresponding to one of the request objects in the set of request objects; and
using the identifiers for each request object to retrieve results from the set of result objects.

12. The method of claim 11, wherein providing the set of request objects comprises:
creating an operation object for each invoked method of a CIM class, wherein each request object in the set of request objects is a created operation object.

13. The method of claim 11, wherein a client application programming interface creates each identifier and the step of creating an identifier further comprises:
providing the identifiers to a client application.

14. The method of claim 11, wherein receiving a set of result objects comprises:
sending, by the client, the set of request objects to the object manager; and
receiving, by the client, the set of result objects from the object manager.

15. The method of claim 11, wherein each result object in the set of result objects is a corresponding request object embedded with a result.

16. The method of claim 11, wherein using the identifiers comprises:
for each identifier:
using the identifier as an input parameter for a result method; and
retrieving a result corresponding to the request object associated with the identifier.

17. The method of claim 13, wherein the step of using the identifiers is performed by a client application and further comprises:
using the identifiers for each request object to retrieve results from a batch result object associated with the received set of result objects.

18. The method of claim 11, wherein creating an identifier comprises:
sending the set of request objects to the object manager using one of an RMI or XML/HTTP protocol.

19. The method of claim 17, wherein sending the set of request objects comprises:
associating each request object with an XML simple request operation; and
adding each XML simple request operation into an XML multiple request operation.

20. A method for performing batch data transfers, the method performed by a client, comprising:
creating a batch request including a set of operations to be performed by an object manager;
sending the batch request to the object manager;
receiving a batch request response from the object manager, wherein the batch request response comprises the set of operations; and
retrieving a result from each operation in the batch request response.

21. The method of claim 20, wherein retrieving comprises:
using an operation identifier assigned to each operation in the set to retrieve the result.

22. The method of claim 20, wherein creating a batch request comprises:
creating a batch request object;
invoking a method from the batch request object;
creating an operation object corresponding to the invoked method; and
placing the operation object into the batch request.

23. The method of claim 20, wherein an application programming interface performs the steps of creating, sending, and receiving, and a client application performs the step of retrieving.

24. A method for performing a batch data transfer, the method performed by an object manager, comprising:
receiving a set of operation objects from a client;
mapping each operation object to a corresponding management operation object;
retrieving a result associated with each management operation object;
embedding each result into the operation object that corresponds to a management operation object associated with the result; and
sending the embedded operation objects to the client.

25. The method of claim 24, wherein the step of mapping comprises:
using a reflection techniques to map each operation object to a corresponding management operation object.

26. The method of claim 25, wherein the operation objects are Common Information Model (CIM) operation objects and the management operation objects are Common Information Model Object Manager (CIMOM) operation objects.

27. The method of claim 24, wherein the step of retrieving a result comprises:
invoking a run method associated with each management operation object.

28. The method of claim 24, wherein the step of retrieving a result comprises:
accessing one of a repository and a provider to obtain the result.

29. The method of claim 28, wherein each operation object included in the set of operation objects corresponds to an operation to be performed by the object manager, and wherein the result is an exception object when the object manager fails to complete the corresponding operation.

30. The method of claim 24, wherein the object manager is a Common Information Model Object Manager (CIMOM) and the management operation objects are CIMOM operation objects.

31. A method for performing a batch data transfer, the method performed by an object manager, comprising:
receiving a batch request operation including a plurality of request operations;
invoking each request operation;
retrieving a result associated with each invoked request operation;
creating a batch result operation including the retrieved results; and
making the batch result operation available to a source reflected by the received batch request operation.

32. The method of claim 31, wherein the batch request operation is sent by the client using an HTTP protocol, and wherein the batch request operation is a multiple XML based operation.

33. The method of claim 32, wherein the request operations are each simple XML based operations, and the step of invoking comprises:
parsing the multiple XML based operation; and
invoking each simple XML based operation.

34. The method of claim 31, wherein the step of retrieving a result comprises:
accessing one of a repository or provider to obtain the result.

35. The method of claim 34, wherein the step of creating a batch result operation comprises:
creating an XML based result operation for each retrieved result; and
inserting each XML based result operation into a multiple XML based result operation.

36. The method of claim 35, wherein the step of sending the batch result operation comprises:
sending the multiple XML based result operation to the source.

37. A system configured to enable a client application for managing resources and requesting a set of operations to be performed associated with the resources, the system comprising:
a client API for creating a set of client operation objects, wherein each client operation object corresponds to a requested operation, and associating an operation identifier with each client operation object; and
an object manager (OM) for receiving the set of client operation objects, creating an OM operation object associated with each client operation object, retrieving a result associated with each OM operation object, and embedding each result into a corresponding client operation object included in the received set,
wherein the OM sends the set of client operation objects embedded with the results to the client API, the client API creates a batch result object based on the set of client operation objects embedded with the results, and the client application uses the operation identifiers to retrieve the results from the batch result object.

38. The system of claim 37, wherein the OM accesses one of a server repository and a server provider to retrieve each result.

39. The system of claim 38, wherein each OM operation object includes a run method and the OM invokes a run method associated with each OM operation object to retrieve a result.

40. The system of claim 37, wherein for each requested operation, the client application invokes a method associated with a batch Common Information Model (CIM) client object, and the client API creates a CIM client operation object corresponding to the requested operation based on the invoked method.

41. The system of claim 37, wherein the OM is a Common Information Model Object Manager (CIMOM) and the OM operation objects are instances of a CIMOM operation class.

42. The system of claim 37, wherein the client application uses an operation identifier as an input parameter for a method to retrieve a result from the batch result object, wherein the retrieved result corresponds to an operation object associated with the operation identifier.

43. A system, comprising
a processor; and
a memory comprising:
a process for creating Common Information Model (CIM) objects, each CIM object corresponding to an operation to be performed by a CIM Object Manager (CIMOM); associating an identifier with each CIM object; sending the CIM objects to the CIMOM, receiving a set of results from the CIMOM, each result in the set corresponding to one of the operations; and creating a result object reflecting the set of results,
wherein the processor executes the process to perform a batch data transfer.

44. A system, comprising:
a processor; and
a memory comprising:
a first process for, when executed by the processor, requesting a set of operations to be performed by a Common Information Model Object Manager (CIMOM); and
a second process for, when executed by the processor, creating CIM objects, each CIM object corresponding to an operation in the set; associating an identifier with each CIM object; and creating a CIM result object reflecting a set of results received from the CIMOM,
wherein the first process uses an identifier to retrieve a result from the CIM result object.

45. A system, comprising:
a processor; and
a memory comprising:
a Common Information Model (CIM) process for, when executed by the processor, receiving a set of operation objects from a client, creating CIM manager objects, each CIM manager object corresponding to an operation object included in the set of operation objects; retrieving a result for each CIM manager object; embedding each result into a corresponding operation object included in the set, and providing the set of operation objects embedded with the results to the client,
wherein the processor executes the CIM process to perform batch data transfers.

46. A system, comprising:
a processor; and
a memory comprising:
a Common Information Model (CIM) process for, when executed by the processor, invoking simple XML operations included in a multiple XML operation received from a client; retrieving a simple XML result for each simple XML operation when it is invoked; placing each simple XML result in a multiple XML result operation;
and providing the multiple XML result operation to the client,
wherein the processor executes the CIM process to perform a batch data transfer.

47. A system for performing batch data transfers comprising:
a client for combining a set of Common Information Model (CIM) requests into a batch request and retrieving a result associated with each CIM request using an identifier assigned to the CIM request; and
a server for processing the batch request such that each result corresponding to a CIM request is retrieved and placed in a list of objects, and making the list of objects available to the client.
